(19) United States
(12) Patent Application Publication
(10) Pub. No.: US 2024/0272034 A1
(43) Pub. Date: Aug. 15, 2024

(54) AIRTIGHTNESS TESTING APPARATUS AND AIRTIGHTNESS TESTING METHOD

(71) Applicant: Mitsubishi Electric Corporation, Tokyo (JP)

(72) Inventors: Yusei ONO, Tokyo (JP); Yasutaka OCHIAI, Tokyo (JP); Makoto SAITO, Tokyo (JP); Yoshihiro DOHGAN, Tokyo (JP); Naohiro ICHIKAWA, Tokyo (JP); Katsuya TANIGUCHI, Tokyo (JP)

(21) Appl. No.: 18/569,639

(22) PCT Filed: Aug. 18, 2021
(86) PCT No.: PCT/JP2021/030167

§ 371 Date: Dec. 13, 2023

(51) Int. Cl. G01M 3/28; G01K 13/02

(52) U.S. Cl. CPC G01M 3/2815; G01K 13/02; F25B 2500/222

(57) ABSTRACT

An airtightness testing apparatus includes a differential pressure gauge and a temperature measuring device. The differential pressure gauge measures a differential pressure between the pressure of a fluid in a refrigerant pipe in an air-conditioning apparatus and that in an airtight reference container. The temperature measuring device is connected with the refrigerant pipe to measure the temperature of the fluid therein, and includes a temperature measurement container and a temperature acquisition module. The temperature measurement container communicates with the refrigerant pipe, and can contain the fluid while being sealed. The temperature acquisition module is provided in the temperature measurement container and measures the temperature of the fluid. The temperature measurement container satisfies one or both of a condition that its thermal diffusivity is higher than or equal to that of the refrigerant pipe and a condition that its thermal conductivity is higher than or equal to that of the pipe.

### CROSS REFERENCE TO RELATED APPLICATION

This application is a U.S. national stage application of PCT/JP2021/030167 filed on Aug. 18, 2021, the contents of which are incorporated herein by reference.

### TECHNICAL FIELD

The present disclosure relates to an airtightness testing apparatus that checks the airtightness of an air-conditioning apparatus and an airtightness testing method of checking the airtightness of the air-conditioning apparatus.

### BACKGROUND

An air-conditioning apparatus is made to contain refrigerant in a sealed state, for example, when being installed or repaired. In order to prevent a leak of the refrigerant from a refrigerant pipe of the air-conditioning apparatus, a nitrogen pressurization leak test is conducted before the air-conditioning apparatus is made to contain the refrigerant in the sealed state. In the nitrogen pressurization leak test, nitrogen is filled into refrigerant pipes, with the refrigerant pipes sealed, and is pressurized. Then, after a predetermined time period elapses, airtightness is determined based on whether the pressure in each of the refrigerant pipes drops or not.

In the nitrogen pressurization leak test, a pressure gauge may be used in order to check the airtightness. However, since the measurement range of the pressure gauge depends on the value of a pressure applied, the measurement range may be widened and responsiveness to a change in the pressure may be worsened. Therefore, it may take a long time to evaluate the airtightness of the refrigerant pipes after the refrigerant pipes containing nitrogen are sealed and pressurized.

The nitrogen pressurization leak test is conducted by not only a method using the pressure gauge, but also a differential pressure gauge method that is applied using a differential pressure gauge. In the differential pressure gauge method, the airtightness of an object to be tested such as an air-conditioning apparatus is checked based on a differential pressure that is the difference between a pressure of nitrogen which is contained in the object sealed, and a pressure of nitrogen which is contained in a sealed reference container for use in comparison. Since the measurement range of the differential pressure gauge does not depend on the value of a pressure applied, the measurement range can be made small. Therefore, the differential pressure gauge method can improve the responsiveness to a change in the pressure.

By contrast, the differential pressure gauge may be affected by a change in the pressure which is made by a change in an outdoor door temperature, since the differential pressure gauge is high in sensitivity. In order to eliminate the effect of such a change in the temperature, in the differential pressure gauge method, it is necessary to measure the temperature of nitrogen when the differential pressure is being measured, and correct the value of the pressure based on the measured temperature.

In the past, the following method has been known: in order to measure the temperature of a fluid filled, a temperature measuring device is attached to, for example, a surface of a refrigerant pipe, and estimate the temperature of a fluid in the refrigerant pipe based on the surface temperature of the refrigerant pipe. In this method, however, a change in the temperature of the fluid in the refrigerant pipe may lag behind a change in the outdoor air temperature by time which is required for heat conduction. Therefore, the temperature measured by the temperature measuring device may have an error with reference to the temperature of the fluid in the refrigerant pipe. As a configuration to reduce such an error, Patent Literature 1 discloses a configuration in which a temperature detector exposed in a refrigerant pipe directly measures the temperature of a fluid in the refrigerant pipe.

### Patent Literature

Patent Literature 1: Japanese Unexamined Patent Application Publication No. Sho 63-170121

It should be noted that an outdoor unit of an air-conditioning apparatus is exposed to outdoor air, whereas an indoor unit thereof is not exposed to outdoor air, a temperature difference between a fluid in the outdoor unit and a fluid in the indoor unit can be made. Since the outdoor unit may include a heat exchanger having a large surface area, and a change in outdoor air temperature is considered greater than a change in indoor temperature, the temperature of the fluid in the outdoor unit is considered as a representative temperature on which the magnitude of the pressure of a fluid in the air-conditioning apparatus depends. Therefore, it is preferable that a temperature measuring device measure the temperature of a fluid in a refrigerant pipe in the outdoor unit in order to highly accurately correct the value of the pressure of the fluid based on the temperature measured by the temperature measuring device.

Furthermore, assuming that heat diffusion in the air-conditioning apparatus is caused by the migration of molecules of the fluid, it is conceivable that the temperature which is measured by the temperature measuring device also depends on the temperature of the temperature measuring device itself. Therefore, in correction of the value of the pressure of the fluid, it is necessary for the temperature measuring device to measure the temperature of the fluid which is affected by the temperature of ambient air after the temperature measuring device itself exchanges heat with the ambient air. For example, in the case where the temperature measuring device measures the temperature of the fluid in the refrigerant pipe in the outdoor unit, the temperature measuring device needs to measure the temperature of the fluid which is affected by the temperature of outdoor air after the temperature measuring device itself exchanges heat with the outdoor air. However, Patent Literature 1 fails to disclose a configuration in which the temperature measuring device itself exchanges heat with ambient air. Thus, in this Patent Literature, the accuracy of measurement of the temperature of a fluid can be reduced. Therefore, in the past, the value of the pressure of a fluid which is corrected based on the temperature of the fluid has had an error with reference to an actual value of the pressure, and as a result, there has been a possibility that the accuracy of an airtightness test may be reduced.

### SUMMARY

The present disclosure is applied to solve the above problems and relates to an airtightness testing apparatus and an airtightness testing method that improves the accuracy of an airtightness test on a refrigerant pipe.

An airtightness testing apparatus according to an embodiment of the present disclosure is an airtightness testing apparatus to test airtightness of a refrigerant pipe in an air-conditioning apparatus. The airtightness testing apparatus includes: a differential pressure gauge configured to measure a differential pressure that is a difference between a pressure of a fluid filled into the refrigerant pipe and a pressure of a fluid filled into a reference container that is airtight; and a temperature measuring device connected with the refrigerant pipe, and configured to measure a temperature of the fluid in the refrigerant pipe. The temperature measuring device includes a temperature measurement container that communicates with the refrigerant pipe and that is allowed to contain the fluid while being sealed, and a temperature acquisition module provided in the temperature measurement container and configured to measure the temperature of the fluid. The temperature measurement container is configured to satisfy one or both of a condition that a thermal diffusivity of the temperature measurement container is higher than or equal to a thermal diffusivity of the refrigerant pipe and a condition that a thermal conductivity of the temperature measurement container is higher than or equal to a thermal conductivity of the refrigerant pipe.

An airtightness testing method according to another embodiment of the present disclosure is an airtightness testing method that is applied by an airtightness testing apparatus to conduct a test on airtightness of a refrigerant pipe in an air-conditioning apparatus. The airtightness testing apparatus includes a temperature measuring device connected with the refrigerant pipe. The temperature measuring device includes a temperature measurement container that communicates with the refrigerant pipe and that is allowed to contain the fluid while being sealed, and a temperature acquisition module provided in the temperature measurement container and configured to measure a temperature of the fluid. The temperature measurement container is configured to satisfy one or both of a condition that a thermal diffusivity of the temperature measurement container is higher than or equal to a thermal diffusivity of the refrigerant pipe and a condition that a thermal conductivity of the temperature measurement container is higher than or equal to a thermal conductivity of the refrigerant pipe. The airtightness testing method is applied, with the temperature measuring device set in an outdoor unit in the air-conditioning apparatus, and includes: measuring a differential pressure that is a difference between a pressure of the fluid filled in the refrigerant pipe and a pressure of the fluid filled in a reference container that is airtight; and measuring the temperature of the fluid in the refrigerant pipe.

In the airtightness testing apparatus and the airtightness testing method according to the embodiments of the present disclosure, the temperature measurement container is configured to satisfy one or both of the condition that the thermal diffusivity of the temperature measurement container is higher than or equal to that of the refrigerant pipe and the condition that the thermal conductivity of the temperature measurement container is higher than that of the refrigerant pipe. As a result, the temperature of the fluid in the temperature measurement container and the temperature of the fluid in the refrigerant pipe come close to each other. Therefore, since the temperature acquisition module measures the temperature of the fluid in the temperature measurement container, the temperature measuring device can highly accurately measure the temperature of the fluid in the refrigerant pipe. Therefore, in the airtightness testing apparatus, it is possible to highly accurately correct the value of the pressure of the fluid based on the temperature obtained with a high degree of accuracy. Thus, the accuracy of the airtightness test based on the differential pressure between the pressure of the fluid in the refrigerant pipe and the pressure of the fluid in the reference container is improved.

### BRIEF DESCRIPTION OF DRAWINGS

FIG. 1 is a block diagram illustrating a configuration example of an airtightness testing apparatus according to Embodiment 1.

FIG. 2 is a schematic view illustrating a configuration example of a temperature measuring device in Embodiment 1.

FIG. 3 is a schematic view illustrating an example of installation of the airtightness testing apparatus according to Embodiment 1.

FIG. 4 is a flow chart of the flow of processes in the first half of an airtightness test according to Embodiment 1.

FIG. 5 is a flow chart of the flow of processes in the second half of the airtightness test according to Embodiment 1.

FIG. 6 is a schematic view illustrating an example of installation of an airtightness testing apparatus according to Embodiment 2.

FIG. 7 is a block diagram illustrating a configuration example of an airtightness testing apparatus 200 according to Embodiment 3.

FIG. 8 is a schematic view illustrating an example of installation of the airtightness testing apparatus according to Embodiment 3.

FIG. 9 is a flow chart of the flow of processes in an airtightness test according to Embodiment 3.

### DETAILED DESCRIPTION

Airtightness testing apparatuses according to the embodiments will be described in detail with reference to the drawings. It should be noted that in figures that will be referred to below, relationships in size between components may be different from actual ones.

### Embodiment 1

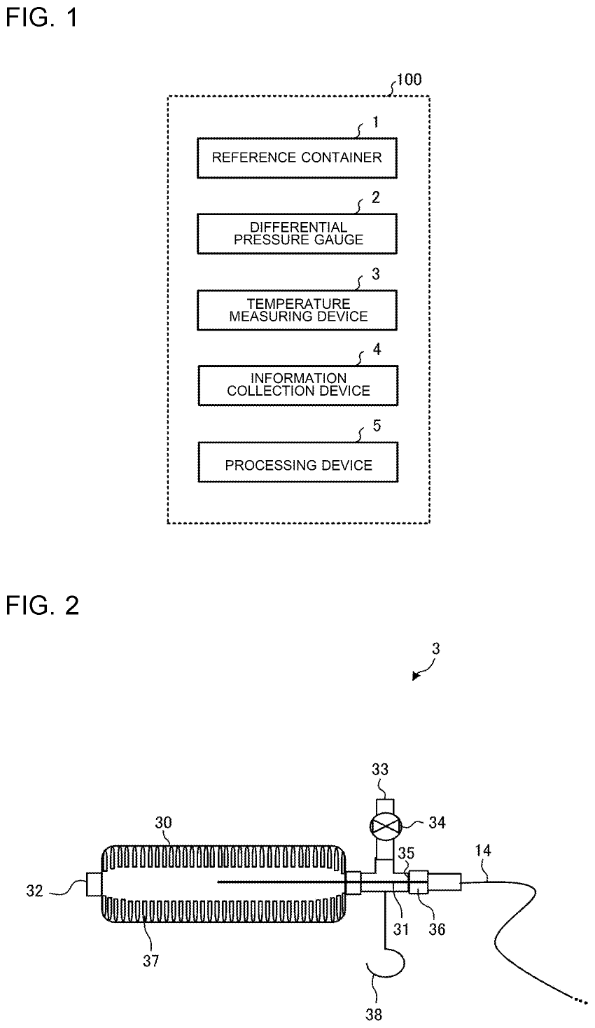

FIG. 1 is a block diagram illustrating a configuration example of an airtightness testing apparatus according to Embodiment 1. The airtightness testing apparatus 100 is an apparatus that conducts a test on the airtightness of a refrigerant pipe in an air-conditioning apparatus and includes a reference container 1, a differential pressure gauge 2, a temperature measuring device 3, an information collection device 4, and a processing device 5. In order that the components of the airtightness testing apparatus 100 be easily understood, in FIG. 1, the reference container 1, the differential pressure gauge 2, etc., are indicated in a dashed frame. However, the configuration of those components is limited to a configuration in which the components are provided together in a single housing.

The reference container 1 is an airtight container that does not allow a leak of a fluid, such as a nitrogen gas, in the case where a fluid is filled in the airtight container, with the airtight container sealed. In Embodiment 1, the reference container 1 has heat insulating properties. In an airtightness test that is conducted using the airtightness testing apparatus 100, the airtightness of a refrigerant pipe is checked based on the pressure of a fluid which is filled in the refrigerant pipe, with the refrigerant pipe sealed, with reference to the pressure of the fluid filled in the sealed reference container 1.

The differential pressure gauge 2 is connected with the refrigerant pipe and the reference container 1 and configured to measure a differential pressure that is the difference between the pressure of the fluid in the refrigerant pipe and the pressure of the fluid in the reference container 1. In the following, the “pressure” covers “value of pressure”, and the “differential pressure” covers “value of differential pressure”. The temperature measuring device 3 measures the temperature of the fluid in the refrigerant pipe.

The information collection device 4 is, for example, a data logger, and collects the results of measurements made by the differential pressure gauge 2 and the temperature measuring device 3. The processing device 5 performs processing based on data collected by the information collection device 4.

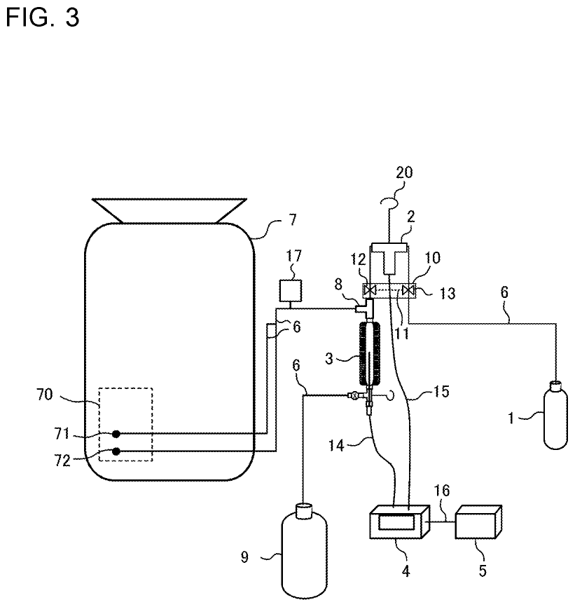

FIG. 2 is a schematic view illustrating a configuration example of the temperature measuring device in Embodiment 1. FIG. 3 is a schematic view illustrating an example of installation of the airtightness testing apparatus according to Embodiment 1. The temperature measuring device 3 includes a temperature measurement container 30 and a temperature acquisition module 31. The temperature measurement container 30 is a container that can contain a fluid in a sealed state and that forms an outer shell of the temperature measuring device 3. The temperature measurement container 30 is made of metal, for example.

The temperature measurement container 30 is connected with a refrigerant pipe 70 in an outdoor unit 7 by an inspection pipe 6, and a space in the temperature measurement container 30 communicates with a space in the refrigerant pipe 70 via the inspection pipe 6. Therefore, in the case where a fluid is filled in the refrigerant pipe 70 or in the temperature measurement container 30 in a sealed state, the fluid can flow between the temperature measurement container 30 and the refrigerant pipe 70.

The temperature measurement container 30 in Embodiment 1 satisfies one or both of a condition that the thermal diffusivity of the temperature measurement container 30 is higher than or equal to that of the refrigerant pipe 70 and a condition that the thermal conductivity of the temperature measurement container 30 is higher than or equal to that of the refrigerant pipe 70. The temperature measurement container 30 and the refrigerant pipe 70 may be made of the same material. For example, the temperature measurement container 30 may be made of copper, which is widely used as the material of the refrigerant pipe 70. The temperature measurement container 30 may be obtained by processing the refrigerant pipe 70.

It should be noted that a thermal capacity increases as an inner capacity increases. In order to shorten the period of time that is required until heat is conducted to the fluid in the temperature measurement container 30 from the outside thereof, it is preferable the inner capacity of the temperature measurement container 30 be small. In Embodiment 1, it is assumed that the inner capacity of the temperature measurement container 30 is less than or equal to, for example, 50 cm³.

The temperature measurement container 30 has a pipe-side connection port 32 for use in connection of the temperature measurement container 30 to the refrigerant pipe 70. The pipe-side connection port 32 is defined, for example, by a flared female coupling. With the inspection pipe 6 connected with the pipe-side connection port 32, the temperature measurement container 30 is connected, by the inspection pipe 6, to the refrigerant pipe 70 or a manifold that bundles refrigerant pipes 70. Thus, the space in the temperature measurement container 30 and the space in the refrigerant pipe 70 communicate with each other. In Embodiment 1, at the pipe-side connection port 32, a branching tool 8, such as Tees, is provided. By the branching tool 8, the inspection pipe 6 is connected with the pipe-side connection port 32.

The temperature measurement container 30 has a fluid-reception connection port 33 for connection of the temperature measurement container 30 to a fluid supply device 9. The fluid supply device 9 is, for example, a nitrogen gas cylinder, and supplies a fluid into the refrigerant pipe 70 and the reference container 1. In Embodiment 1, the fluid supply device 9 is provided with a supply side valve (not illustrated) that allows the fluid to flow out from the fluid supply device 9 when the supply side valve is in an open state.

The fluid-reception connection port 33 is defined, for example, by a flared male coupling. An inspection pipe 6 is connected with the fluid-reception connection port 33, and the temperature measurement container 30 is connected with the fluid supply device 9 by the inspection pipe 6. The refrigerant pipe 70 is connected with the fluid supply device 9 via the temperature measurement container 30.

At the fluid-reception connection port 33, a first valve 34 is provided. When being in an open state, the first valve 34 allows a fluid that flows out from the fluid supply device 9 to flow into the temperature measurement container 30. As a result, the temperature measurement container 30 and the refrigerant pipe 70 are filled with the fluid that flows out from the fluid supply device 30. When being in a closed state, the first valve 34 does not allow the fluid that flows out from the fluid supply device 9 to flow into the temperature measurement container 30. As a result, the fluid that flows out from the fluid supply device 9 does not flow into the temperature measurement container 30 or into the refrigerant pipe 70. It is preferable that the first valve 34 be a valve that holds a stop valve, and be, for example a packless valve.

In the case where the refrigerant pipe 70 is filled with a predetermined set filling amount of a fluid, the temperature measurement container 30 has such pressure resistance as to withstand a pressure that is higher than or equal to a first pressure corresponding to the set filling amount. It should be noted that the set filling amount means the total amount of a fluid that is filled into the refrigerant pipe 70 in an airtightness test for the check of the airtightness of the refrigerant pipe 70. The set filling amount is determined in advance as an amount of the fluid that is required to secure the pressure resistance of the refrigerant pipe 70 in the time required to check the airtightness of the refrigerant pipe 70 and as an amount of the fluid to which the amount of the fluid to be used can be reduced. The first pressure corresponding to the set filling amount is, for example, 2 MPa.

The temperature measurement container 30 has an external opening 35 through which the space in the temperature measurement container 30 and an external space communicate with each other. At the external opening 35, a seal material 36 is provided to close the external opening 35. It is assumed that even if a fluid having a fluid having a high pressure higher than or equal to the first pressure is filled into the temperature measurement container 30, the seal material 36 can withstand such a pressure. It is preferable that the seal material 36 be a compression fitting.

The temperature acquisition module 31 is provided in the temperature measurement container 30 to measure the temperature of the fluid in the temperature measurement container 30. In Embodiment 1, the temperature acquisition module 31 is provided in the seal material 36. It is assumed that even if a fluid having a higher pressure higher than or equal to the first pressure is filled into the temperature measurement container 30, the temperature acquisition module 31 can withstand such a pressure. It is preferable that the temperature acquisition module 31 be a sheathed thermocouple that is high in responsiveness and that could withstand a high-pressure condition over a long period of time.

In the temperature measurement container 30, a plurality of fins 37 are provided. The plurality of fins 37 are made of aluminum, for example. It is preferable that the plurality of fins 37 be uniformly arranged in the temperature measurement container 30. Because of provision of the plurality of fins 37, the surface area of the inside of the temperature measurement container 30 is increased. As a result, the temperature acquisition module 31 can detect a change in the temperature of the fluid in the temperature measurement container 30 with high sensitivity.

The temperature measuring device 3 is provided with a first attachment tool 38. The first attachment tool 38 is, for example, an attachment hook or other tools. It is preferable that the first attachment tool 38 be made of steel of high durability, although the material of the first attachment tool 38 is not limited.

The temperature measuring device 3 is installed by the first attachment tool 38 in the same environment as the outdoor unit 7. For example, the temperature measuring device 3 is installed by the first attachment tool 38 at a location where the distance between the temperature measuring device 3 and the refrigerant pipe 70 in the outdoor unit 7 is shorter than or equal to a predetermined first distance. The first distance is longer than or equal to 10 cm and equal to or shorter than 50 cm. In Embodiment 1, in order to avoid complication of each of the figures, FIG. 3 illustrates the temperature measuring device 3 provided outside the outdoor unit 7; however, it is assumed that the temperature measuring device 3 is provided in the outdoor unit 7,.

It is possible that the temperature of the fluid in the temperature measurement container 30 and the temperature of the fluid in the refrigerant pipe 70 in the outdoor unit 7 are close to each other, for example by installing the temperature measuring device 3 at a position close to the refrigerant pipe 70 in the outdoor unit 7 and setting the thermal diffusivity of the temperature measurement container 30 to a value higher than or equal to the thermal diffusivity of the refrigerant pipe 70. Furthermore, the temperature of the fluid in the temperature measurement container 30 and the temperature of the fluid in the refrigerant pipe 70 in the outdoor unit 7 can be made close to each other, for example, by installing the temperature measuring device 3 at a location close to the refrigerant pipe 70 in the outdoor unit 7 and equalizing the thermal conductivity of the temperature measurement container 30 to the thermal conductivity of the refrigerant pipe 70. Therefore, since the temperature acquisition module 31 measures the temperature of the fluid in the temperature measurement container 30, the temperature measuring device 3 can highly accurately measure the temperature of the fluid in the refrigerant pipe 70.

The temperature acquisition module 31 is connected with the information collection device 4 by a first signal line 14 and transmits a measured temperature to the information collection device 4. It should be noted the temperature acquisition module 31 may perform wireless communication with the information collection device 4 instead of cable communication using the first signal line 14 and may transmit the measured temperature to the information collection device 4 through wireless communication.

The differential pressure gauge 2 is connected with two couplings in the refrigerant pipe 70 by an inspection pipe 6 and a guide device 10. In Embodiment 1, one of the two couplings is provided on a discharge side of a compressor (not illustrated) in the outdoor unit 7, and the other is provided on a suction side of the compressor. In the following, the coupling provided on the discharge side of the compressor is hereinafter sometimes referred to as “high-pressure coupling 71”; and the coupling provided on the suction side of the compressor is hereinafter sometimes referred to as “low-pressure coupling 72”. It should be noted that the inspection pipe 6 which connects the differential pressure gauge 2 to the above two couplings has two branches that are connected with the two couplings. A fluid in the high-pressure coupling 71 and a fluid in the low-pressure coupling 72 flow to the differential pressure gauge 2 through the inspection pipe 6. At this time, the fluid from the high-pressure coupling 71 and the fluid from the low-pressure coupling 72 join each other at the junction of the two branches of the inspection pipe 6, which is close to the differential pressure gauge 2, and flow to the differential pressure gauge 2.

The differential pressure gauge 2 is connected with the reference container 1 via an inspection pipe 6 and the guide device 10. Thus, the fluid in the reference container 1 flows to the differential pressure gauge 2.

The guide device 10 includes a branch pipe 11, a second valve 12, and a third valve 13. The branch pipe 11 connects the following two inspection pipes 6. One of the two inspection pipes 6 is an inspection pipe 6 connecting the differential pressure gauge 2 to the high-pressure coupling 71 and the low-pressure coupling 72. The other of the two inspection pipes 6 is an inspection pipe 6 connecting the differential pressure gauge 2 to the reference container 1. It should be noted that in FIG. 3, the branch pipe 11 is indicated by a dashed line in order that the branch pipe 11 be distinguished from the inspection pipes 6.

The second valve 12 is provided at the inspection pipe 6 connecting the differential pressure gauge 2 to the high-pressure coupling 71 and the low-pressure coupling 72 and also at the branch pipe 11. When being in an open state, the second valve 12 allows the fluid that flows out from the refrigerant pipe 70 at the high-pressure coupling 71 and the low-pressure coupling 72 to flow to the branch pipe 11. In Embodiment 1, when being in the open state, the second valve 12 allows the fluid from the refrigerant pipe 70 at the high-pressure coupling 71 and the low-pressure coupling 72, to flow to the differential pressure gauge 2. However, when being in the open state, the second valve 12 may block the flow of the fluid from the refrigerant pipe 70 at the high-pressure coupling 71 and the low-pressure coupling 72 to the differential pressure gauge 2. When being in a closed state, the second valve 12 blocks the flow of the fluid from the refrigerant pipe 70 at the high-pressure coupling 71 and the low-pressure coupling 72 to the branch pipe 11. Furthermore, when being in the closed state, the second valve 12 allows the fluid from the refrigerant pipe 70 at the high-pressure coupling 71 and the low-pressure coupling 72 to flow to the differential pressure gauge 2.

The third valve 13 is provided at the inspection pipe 6 which connects the differential pressure gauge 2 to the reference container 1 and also at the branch pipe 11. When being in an open state, the third valve 13 allows a fluid which flows out from the reference container 1 to flow to the branch pipe 11. In Embodiment 1, when being in the open state, the third valve 13 allows the fluid from the reference container 1 to flow to the differential pressure gauge 2. However, when being in the open state, the third valve 13 may block the flow of the fluid from the reference container 1 to the differential pressure gauge 2. When being in a closed state, the third valve 13 blocks the flow of the fluid from the reference container 1 to the branch pipe 11. Furthermore, when being in the closed state, the third valve 13 allows the fluid from the reference container 1 to flow to the differential pressure gauge 2.

When the second valve 12 and the third valve 13 are made to be in the open state, the inside of the refrigerant pipe 70 and the inside of the reference container 1 communicate with each other, and as a result, the fluid flows between the refrigerant pipe 70 and the reference container 1. In contrast, when the second valve 12 and the third valve 13 are made to be in the closed state, the fluid is not allowed to flow between the refrigerant pipe 70 and the reference container 1.

In Embodiment 1, the differential pressure gauge 2 is connected with the high-pressure coupling 71 and the low-pressure coupling 72 via the branching tool 8 provided at the pipe-side connection port 32 of the temperature measurement container 30. Because of provision of the above configuration, the temperature measurement container 30, the refrigerant pipe 70, and the differential pressure gauge 2 are connected. It should be noted that the second valve 12 in the guide device 10 is located between the differential pressure gauge 2 and the branching tool 8.

When the first valve 34, the second valve 12, and the third valve 13 are made to be in the open state, the fluid which flows out from the fluid supply device 9 flows into the temperature measurement container 30, the refrigerant pipe 70, and the reference container 1. As a result, the fluid is filled into the temperature measurement container 30, the refrigerant pipe 70, and the reference container 1.

The differential pressure gauge 2 measures a differential pressure that is the difference between the pressure of the fluid in the refrigerant pipe 70 and the pressure of the fluid in the reference container 1 after equalization of the pressure of the fluid filled into the temperature measurement container 30, the pressure of the fluid filled into the refrigerant pipe 70, and the pressure of the fluid filled into the reference container 1. The differential pressure gauge 2 is connected with the information collection device 4 by a second signal line 15 and transmits the measured differential pressure to the information collection device 4. Alternatively, the differential pressure gauge 2 may perform wireless communication with the information collection device 4 instead of cable communication via the second signal line 15, and transmit the measured differential pressure to the information collection device 4 through wireless communication.

The information collection device 4 stores the results of measurement from the temperature measuring device 3 and the differential pressure gauge 2. The information collection device 4 communicates with the processing device 5 via a third signal line 16. Alternatively, the information collection device 4 may perform wireless communication with the processing device 5 instead of cable communication using the third signal line 16.

The processing device 5 receives information to be stored in the information collection device 4 and perform processing using the received information. It should be noted that the processing device 5 and the information collection device 4 may be integrated with each other.

The processing device 5 determines whether the fluid leaks from the refrigerant pipe 70 or not based on the result of measurement made by the differential pressure gauge 2. The determination whether the fluid leaks from the refrigerant pipe 70 or not is made in the following manner. After the supply side valve, the first valve 34, the second valve 12, and the third valve 13 are opened and fluids are filled into the refrigerant pipe 70 and the reference container 1, the supply side valve is closed, whereby the pressure of the fluid in the refrigerant pipe 70 and the pressure of the fluid in the reference container 1 are equalized. After the pressures of those fluids are equalized, the second valve 12, the third valve 13, and other valves are closed. The processing device 5 determines whether the fluid leaks from the refrigerant pipe 70 or not based on the differential pressure measured by the differential pressure gauge 2 after a test time elapses from the point of time at which the pressure of the fluid in the refrigerant pipe 70 and the pressure of the fluid in the reference container 1 are equalized. The test time is a period of time that is set for the airtightness test. For example, the test time is three hours or less. It should be noted that instead of the processing device 5, a worker for the test may determine whether the fluid leaks from the refrigerant pipe 70 or not based on the result of measurement made by the differential pressure gauge 2.

The processing device 5 may be configured to perform timing processing to determine whether the test time elapses or not, for example. The processing device 5 may control at least one of the first valve 34, the second valve 12, the third valve 13, and the supply side valve and control the opening degree of the above at least one valve. In this case, the processing device 5 may be connected by a control line (not illustrated) to the above at least one valve, and by transmitting a control signal to the at least valve, control the opening degree thereof. Alternatively, by wirelessly transmitting a control signal to the above at least one valve, the processing device 5 may control the opening degree thereof.

The processing device 5 can be formed to include a processor, such as a central processing unit (CPU) or a micro processing unit (MPU), a memory, such as a read-only memory (ROM) or a random-access memory (RAM), a communication interface circuit, and a bus that connects these components. In the case where the processing device 5 is configured to perform the timing processing, the processing device 5 may include a timing device, such as a real-time clock (RTC) or may include a communication interface circuit for reception of information indicating time which is sent from the exterior. Alternatively, the processing device 5 may be configured to perform the timing processing by software processing which is performed by the processor and the memory. The processing device 5 may include hardware such as a complex programmable logic device (CPLD) or a field programmable gate array (FPGA) either instead of or in addition to the processor, the memory, etc.

At the inspection pipe 6 which connects the differential pressure gauge 2 to the high-pressure coupling 71 and the low-pressure coupling 72, a pressure measuring device 17 is provided to measure the pressure of the fluid in the refrigerant pipe 70. It should be noted that the pressure measuring device 17 is provided at a location posterior to a position at which the fluid from the high-pressure coupling 71 and the fluid from the low-pressure coupling 72 join each other. The pressure measuring device 17 is, for example, a gauge manifold. The pressure measuring device 17 measures the pressure of a fluid at the time of filing the fluid into the refrigerant pipe 70. The pressure measuring device 17 may be removed after measuring the pressure.

The processing device 5 acquires the result of measurement from the pressure measuring device 17 which is transmitted either via a signal line (not illustrated) or through wireless communication. It should be noted that instead of the processing device 5, the worker for the test may acquire the result of measurement by the pressure measuring device 17. The processing device 5 or the worker for the test may acquire, via the information collection device 4, the result of measurement by the pressure measuring device 17. In this case, the information collection device 4 acquires the result of measurement by the pressure measuring device 17 either via a signal line (not illustrated) or through wireless communication.

At the differential pressure gauge 2, a second attachment tool 20 is provided. The second attachment tool 20 is, for example, an attachment hook. It is preferable that the second attachment tool 20 be made of material having high durability, for example, steel, though the material of the second attachment tool 20 is not limited. The differential pressure gauge 2 is attached by the second attachment tool 20 to, for example, an attachment target provided inside or outside the outdoor unit 7. In Embodiment 1, the differential pressure gauge 2 is set together with the temperature measuring device 3 in the outdoor unit 7, although FIG. 3 shows that the differential pressure gauge 2 is set outside the outdoor unit 7, in order to avoid complication of the figure.

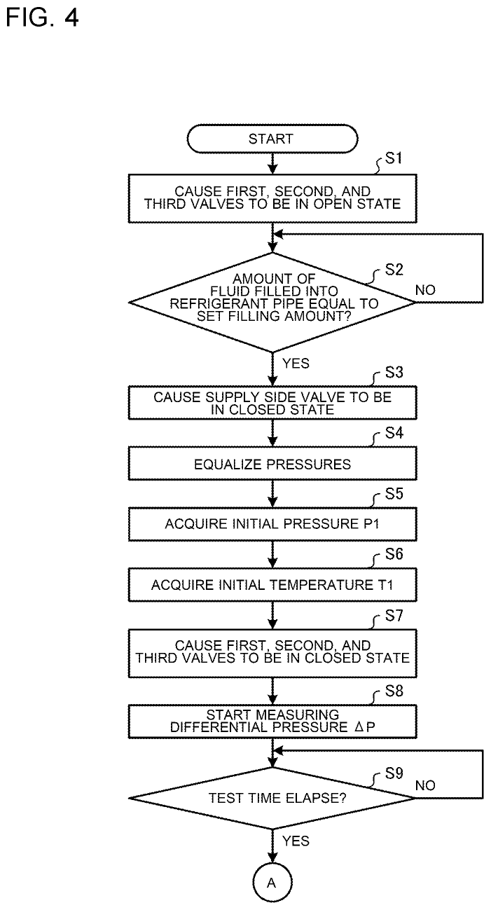

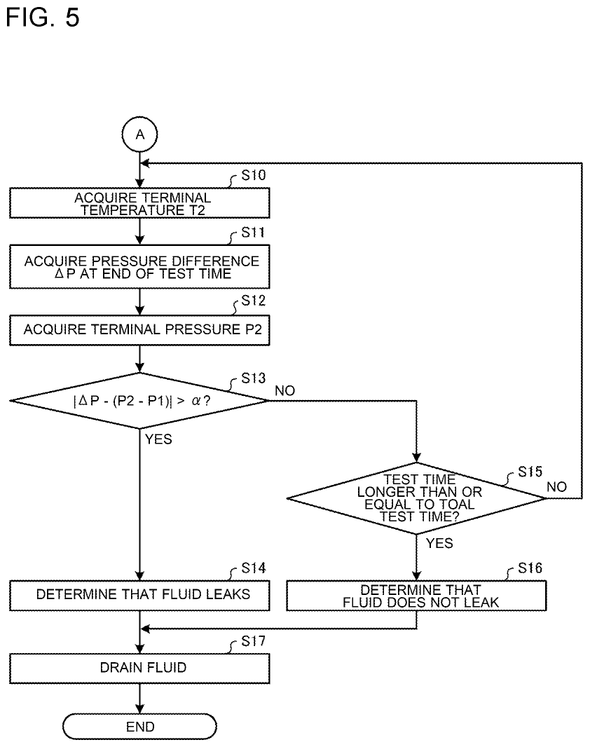

Next, the processing of an airtightness test that is made using the airtightness testing apparatus 100 according to Embodiment 1 will be described with reference to FIGS. 4 and 5. FIG. 4 is a flow chart of the flow of processes in the first half of the airtightness test according to Embodiment 1. FIG. 5 is a flow chart of the flow of processes in the second half of the airtightness test according to Embodiment 1.

In step S1, the first valve 34, the second valve 12, and the third valve 13 are made to be in the open state by a control that is performed by the processing device 5 or are manually made to be in the open state by the worker for the test. At this point in time, the supply side valve in the fluid supply device 9 is also made to be into the open state by the control by the processing device 5 or is also manually made to be in the open state by the worker for the test. When the first valve 34, the second valve 12, the third valve 13, and the supply side valve are made to be in the open state, the fluid flows out from the fluid supply device 9 and flows into the refrigerant pipe 70, the reference container 1, etc. That is, the fluid is filled into the refrigerant pipe 70, the reference container 1, etc.

In step S2, the processing device 5 or the worker for the test determines whether the amount of the fluid filled into the refrigerant pipe 70 reaches the predetermined set filling amount or not. Regarding Embodiment 1, it is assumed that the processing device 5 or the worker for the test determines whether the amount of the fluid filled into the refrigerant pipe 70 reaches the predetermined set filling amount or not, by determining whether the pressure measured by the pressure measuring device 17 reaches the first pressure or not.

In the case where the amount of the fluid filled into the refrigerant pipe 70 is smaller than the predetermined set filling amount (NO in step S2), the processing in the airtightness test is kept in step S2. In the case where the amount of the fluid filled into the refrigerant pipe 70 reaches the predetermined set filling amount (YES in step S2), in step S3, the supply side valve is made to be in the closed state by the control by the processing device 5 or is manually made to be in the closed state by the worker for the test. At this point in time, the first valve 34 may also be made to be in the closed state by the control by the processing device 5 or be manually made to be in the closed state by the worker for the test.

In step S4, the pressures of the fluids in the refrigerant pipe 70, in the temperature measurement container 30, in the reference container 1, etc., are equalized in a pressure equalizing time. It should be noted that the pressure equalizing time is a period of time that is required until the pressures of the fluids in the temperature measurement container 30, in the reference container 1, etc., are equalized and that is determined in advance based on the result of an experiment or other methods. The pressure equalizing time is, for example, 10 min.

In step S5, the processing device 5 acquires, from the pressure measuring device 17, the result of the measurement of the pressure of the fluid in the refrigerant pipe 70 that is obtained after the above equalization of the pressures. Instead of the processing device 5, the worker for the test may acquire the result of the measurement. In the following, the pressure of the fluid in the refrigerant pipe 70 after the equalization of the pressures, which is acquired in step S5, is sometimes referred to as “initial pressure P1”. It should be noted that the processing device 5 or the worker for the test may acquire, via the information collection device 4, the result of the measurement made by the pressure measuring device 17. In this case, the information collection device 4 may be turned on in step S5 to start collecting various information.

In step S6, the processing device 5 or the worker for the test acquires, from the information collection device 4, the temperature measured by the temperature measuring device 3 after the equalization of the pressures. In the following, the temperature acquired in step S6 is sometimes referred to as “initial temperature T1”. The processes of steps S5 and S6 may be executed in reverse order or may be executed in parallel. The information collection device 4 may be turned on in step S6 to start collecting various information.

In step S7, the first valve 34, the second valve 12, and the third valve 13 are made to be in the closed state by the control by the processing device 5 or are manually made to be in the closed state by the worker for the test. In the case where in step S3, the first valve 34 is made together with the supply side valve to be in the closed state, in the step S7, the second valve 12 and the third valve 13 are made to be in the closed state by the control by the processing device 5 or are manually made to be in the closed state by the worker for the test. By the process of step S7, the flow of the fluid between the refrigerant pipe 70 and the reference container 1 is blocked.

In step S8, the differential pressure gauge 2 starts measuring the differential pressure between the pressure of the fluid in the refrigerant pipe 70 and the pressure of a fluid in the reference container 1. In the following, the differential pressure measured by the differential pressure gauge 2 is sometimes referred to as “differential pressure ΔP”, and it is assumed that the differential pressure ΔP is a difference obtained by subtracting the pressure of the fluid in the refrigerant pipe 70 from the pressure of the fluid in the reference container 1. The information collection device 4 acquires the measured differential pressure ΔP from the differential pressure gauge 2.

In step S9, the processing device 5 or the worker for the test determines whether the test time elapses from the process of step S7 or not. When it is determined that the test time does not elapse (NO in step S9), the processing in the airtightness test is kept in step S9. When it is determined that the test time elapses (YES in step S9), in step S10, the processing device 5 or the worker for the test acquires from the information collection device 4, the temperature measured by the temperature measuring device 3 at the end of the test time. In the following, the temperature acquired in step S10 is sometimes referred to as “terminal temperature T2”.

In step S11, the processing device 5 or the worker for the test acquires, via the information collection device 4, the differential pressure ΔP measured by the differential pressure gauge 2 at the end of the test time. The processes of steps S10 and S11 may be executed in reverse order or may be executed in parallel.

The differential pressure gauge 2 may start measuring the differential pressure at the end of the test time, for example, in step S10 or S11, instead of in step S8. In this case, the process of step S8 is omitted. However, in the case where the differential pressure gauge 2 starts measuring the differential pressure in step S8, the worker for the test can check the differential pressure during the test time.

In step S12, using the initial pressure P1, the initial temperature T1, and the terminal temperature T2, the processing device 5 calculates a terminal pressure P2, which is the pressure of the fluid in the refrigerant pipe 70 after the test time, according to Formula (1):

$$P 2 = \{ ( T 2 + 273.15 ) / ( T 1 + 273.15 ) \} \times P 1 \qquad ( 1 )$$

In the case where the worker for the test acquires the initial pressure P1, the initial temperature T1, and the terminal temperature T2 in steps S5, S6, and S10, respectively, the worker for the test inputs the initial pressure P1, the initial temperature T1, and the terminal temperature T2 to the processing device 5 prior to the process of step S12. Alternatively, the arithmetic process of step S12 may be performed by the worker for the test.

The above Formula (1) will be described below. The value by which the terminal pressure P2 changes from the initial pressure P1 is a theoretical variation of the pressure of the fluid due to a change in temperature. It should be noted that the initial pressure P1 is equal to the pressure of the fluid in the reference container 1 at the start of the test time. Therefore, the amount by which the terminal pressure P2 changes from the initial pressure P1 is a theoretical variation of the pressure in the refrigerant pipe 70 with reference to the pressure of the fluid in the reference container 1 at the start of the test time. In the case where the fluid in the reference container 1 is not easily affected by a change in outdoor air temperature, it can be assumed that the pressure of the fluid in the reference container 1 at the end of the test time is equal to the initial pressure P1. Then, it can be assumed that the value by which the terminal pressure P2 changes from the initial pressure P1 is a theoretical value of a differential pressure that is the difference between the pressure of the fluid in the refrigerant pipe 70 at the end of the test time and the pressure of the fluid in the reference container 1 at the end of the test time. In Embodiment 1, since the reference container 1 has heat insulating properties as described above, it can be assumed that the pressure of the fluid in the reference container 1 at the end of the test time is equal to the initial pressure P1. Accordingly, it can be assumed that the value by which the terminal pressure P2 changes from the initial pressure P1 is a theoretical value of the differential pressure that is the difference between the pressure of the fluid in the refrigerant pipe 70 at the end of the test time and the pressure of the fluid in the reference container 1 at the end of the test time.

In step S13, the processing device 5 determines whether the magnitude of {ΔP−(P2−P1)} is greater than a first threshold a or not. That is, the processing device 5 determines whether the following Formula (2) is satisfied or not. It should be noted that |ΔP−(P2−P1)| in Formula (2) is the absolute value of {ΔP−(P2−P1)}, and ΔP in Formula (2) is a differential pressure measured by the differential pressure gauge 2 at the end of the test time.

$$\vert Δ P - ( P 2 - P 1 ) \vert > α \qquad ( 2 )$$

The first threshold a is determined in advance as a value greater than 0, based on the result of an experiment or other methods, in order to prevent occurrence of a leak of the fluid from being determined by mistake even when the magnitude of {ΔP−(P2−P1)} falls within an allowable range that is a margin for error. In the case where the magnitude of {ΔP−(P2−P1)} is greater than the first threshold a (YES in step S13), in step S14, the processing device 5 or the worker for the test determines that the fluid leaks from the refrigerant pipe 70. After the process of step S14, the process of step S17 is executed.

In the case where the magnitude of {ΔP−(P2−P1)} is less than or equal to the first threshold a (No in step S13: NO), in step S15, the processing device 5 or the worker for the test determines whether a total test time elapses from the process of step S7 or not. The total test time is, for example, three hours. When it is determined that the total test time does not elapse (NO in step S15), the processing returns to step S10. In this case, the processing returns to step S10, after a predetermined standby time elapses from the point in time at which the process of step S15 is performed. The standby time falls within, for example, the range of 1 minute to 30 minutes. In the case where the processing returns to step S10 after the standby time elapses, it is assumed that the test time is a period of time obtained by adding the standby time to the original test time.

When the test time is longer than or equal to the total test time (YES in step S15), in step S16, the processing device 5 or the worker for the test determines that the fluid does not leak from the refrigerant pipe 70. After the process of step S16, the process of step S17 is executed.

In step S17, the fluid is drained from the refrigerant pipe 70 or other components. The drainage of the fluid is performed, for example, by removing, from the fluid supply device 9, the inspection pipe 6 connected with the fluid-reception connection port 33 and causing the first valve 34 to be in the open state. After the process of step S17, an airtightness testing processing ends.

The above description concerning step S5 is made with respect to the case where the processing device 5 or the worker for the test acquires as data, the initial pressure P1 via the information collection device 4. However, the process of step S5 may be a process in which only the information collection device 4 acquires as data, the initial pressure P1 from the pressure measuring device 17, and the processing device 5 or the worker for the test may acquire as data, the initial pressure P1 from the information collection device 4 in or after step S5 and prior to step S12.

Although it is described above that in step S6, the processing device 5 or the worker for the test acquires as data, the initial temperature T1 from the temperature acquisition module 31 via the information collection device 4, the process of step S6 may be a process in which only the information collection device 4 acquires the initial temperature T1 from the temperature acquisition module 31, and the processing device 5 or the worker for the test may acquire as data, the initial temperature T1 from the information collection device 4 in or after step S6 and prior to step S12.

Although it is described above that in step S10, the processing device 5 or the worker for the test acquires the terminal temperature T2 from the temperature acquisition module 31 via the information collection device 4, the process of step S10 may be a process in which only the information collection device 4 acquires as data, the terminal temperature T2 from the temperature acquisition module 31, and the processing device 5 or the worker for the test may acquire as data, the terminal temperature T2 from the information collection device 4 in or after step S10 and prior to step S12.

Although it is described above that in step S13, the determination whether {ΔP−(P2−P1)} is greater than the first threshold a or not is made by the processing device 5, the determination may be made by the worker for the test instead of by the processing device 5. In this case, the worker for the test may acquire as data, the initial pressure P1 and the differential pressure ΔP in steps S5 and S11, respectively, and may calculate the terminal pressure P2 in step S12. In the case where the worker for the test acquires the differential pressure ΔP in step S11 and the processing device 5 makes the determination of step S13, the worker for the test inputs the differential pressure ΔP to the processing device 5 prior to step S13.

Advantages obtained by the airtightness testing apparatus 100 according to Embodiment 1 will be described. The airtightness testing apparatus 100 is configured to conduct a test on the airtightness of the refrigerant pipe 70 in an air-conditioning apparatus. The airtightness testing apparatus 100 includes the differential pressure gauge 2 and the temperature measuring device 3. The differential pressure gauge 2 measures a differential pressure that is the difference between the pressure of a fluid filled into the refrigerant pipe 70 and the pressure of a fluid filled into the reference container 1. It should be noted that the reference container 1 is airtight. The temperature measuring device 3 is connected with the refrigerant pipe 70 and measures the temperature of the fluid in the refrigerant pipe 70. The temperature measuring device 3 includes the temperature measurement container 30 and the temperature acquisition module 31. The temperature measurement container 30 communicates with the refrigerant pipe, and can contain the fluid in a sealed state. The temperature acquisition module 31 is provided in the temperature measurement container 30 to measure the temperature of the fluid. The temperature measurement container 30 satisfies one or both of a condition that the thermal diffusivity of the temperature measurement container 30 is higher than or equal to the thermal diffusivity of the refrigerant pipe 70 and a condition that the thermal conductivity of the temperature measurement container 30 is higher than or equal to the thermal conductivity of the refrigerant pipe 70.

By virtue of the above configuration, the rate of a change in the temperature of the temperature measurement container 30 that is made by a change in the outdoor air temperature is higher than or equal to the rate of a change in the temperature of the refrigerant pipe 70 that is made by the change in the outdoor air temperature. Therefore, in the case where the outdoor air temperature changes, the temperature of the fluid in the temperature measurement container 30 changes at a rate higher than or equal to the rate of the change in the temperature of the fluid in the refrigerant pipe 70. Thus, the delay in the change in the temperature of the fluid in the temperature measurement container 30, from the change in the temperature of the fluid in the refrigerant pipe 70, is reduced, and as a result, the temperature of the fluid in the refrigerant pipe 70 and the temperature of the fluid in the temperature measurement container 30 become close to each other. Therefore, the temperature measuring device 3 can highly accurately measure the temperature of the fluid in the refrigerant pipe 70. Although the differential pressure ΔP measured by the differential pressure gauge 2 depends on the change in the temperature of the fluid in the refrigerant pipe 70, by applying the airtightness test which is conducted using the airtightness testing apparatus 100 according to Embodiment 1, the accuracy of the determination of the airtightness is improved, since the temperature of the fluid which is obtained with a high degree of accuracy is used together with the differential pressure ΔP.

In Embodiment 1, the temperature measuring device 3 is provided in the same environment as the outdoor unit 7 in the air-conditioning apparatus. In many cases, the outdoor temperature greatly varies, as compared with the indoor temperature. Thus, the temperature of the fluid in the refrigerant pipe 70 can vary depending on a change in temperature in the environment in which the outdoor unit 7 is provided. In Embodiment 1, since the temperature measuring device 3 is provided in the same environment as the outdoor unit 7, the temperature of the fluid in the temperature measurement container 30 comes close to the temperature of the fluid in the refrigerant pipe 70 in the outdoor unit 7. Thus, the temperature measuring device 3 can highly accurately measure the temperature of the fluid in the refrigerant pipe 70 in the outdoor unit 7, which affects the differential pressure ΔP. Therefore, by applying the airtightness test by the airtightness testing apparatus 100 according to Embodiment 1, the accuracy of the determination of the airtightness is improved, as the temperature of the fluid in the outdoor unit 7 which is obtained with a high degree of accuracy is used together with the differential pressure ΔP.

In Embodiment 1, the temperature measuring device 3 is provided in the outdoor unit 7. It should be noted that in many cases, the outdoor temperature more greatly varies than the indoor temperature. Thus, a change in the temperature of the fluid in the refrigerant pipe 70 is considered to be more greatly affected by a change in the temperature in the outdoor unit 7 than by a change the temperature in the indoor unit. In Embodiment 1, since the temperature measuring device 3 is provided in the same environment as the refrigerant pipe 70 in the outdoor unit 7, the temperature of the fluid in the temperature measurement container 30 comes close to the temperature of the fluid in the refrigerant pipe 70 in the outdoor unit 7. Thus, the temperature measuring device 3 can highly accurately measure the temperature of the fluid in the refrigerant pipe 70 in the outdoor unit 7, which affects the differential pressure ΔP. Therefore, by applying the airtightness test by the airtightness testing apparatus 100 according to Embodiment 1, the accuracy of determination of the airtightness is improved, since the temperature of the fluid in the outdoor unit 7 which is obtained with a high degree of accuracy is used together with the differential pressure ΔP.

In Embodiment 1, in the temperature measurement container 30, a plurality of fins 37 are provided, thereby increasing the surface area of the inside of the temperature measurement container 30. Thus, heat exchange between the fluid in the temperature measurement container 30 and outdoor air is promoted. Therefore, in the case where the outdoor air temperature varies, a delay in the change in the temperature of the fluid in the temperature measurement container 30, from the change in temperature of the fluid in the refrigerant pipe 70, is reduced. Therefore, the temperature of the fluid in the refrigerant pipe 70 and the temperature of the fluid in the temperature measurement container 30 comes close to each other. Thus, the temperature measuring device 3 can highly accurately measure the temperature of the fluid in the refrigerant pipe 70, and the accuracy of the airtightness test is improved.

In Embodiment 1, the temperature measurement container 30 and the refrigerant pipe 70 are made of the same material. Therefore, the effect of the outdoor air temperature on the temperature of the fluid in the temperature measurement container 30 is the same as the effect of the outdoor air temperature on the temperature of the fluid in the refrigerant pipe 70. Thus, the temperature of the fluid in the temperature measurement container 30 comes close to the temperature of the fluid in the refrigerant pipe 70 in the outdoor unit 7. Accordingly, the temperature measuring device 3 can highly accurately measure the temperature of the fluid in the refrigerant pipe 70, and the accuracy of the airtightness test is improved.

In Embodiment 1, the temperature measurement container 30 is obtained by processing the refrigerant pipe 70. Therefore, the effect of the outdoor air temperature on the temperature of the fluid in the temperature measurement container 30 is the same as the effect of the outdoor air temperature on the temperature of the fluid in the refrigerant pipe 70. Thus, the temperature of the fluid in the temperature measurement container 30 comes close to the temperature of the fluid in the refrigerant pipe 70 in the outdoor unit 7. Accordingly, the temperature measuring device 3 can highly accurately measure the temperature of the fluid in the refrigerant pipe 70, and the accuracy of the airtightness test is improved.

In Embodiment 1, the temperature measurement container 30 has an inner capacity less than or equal to 50 cm³. Thus, it is possible to shorten a period of time that is required until external heat is conducted to the fluid in the temperature measurement container 30, and is therefore possible to reduce a delay in the change in temperature of the fluid in the temperature measurement container 30, from the change in temperature of the fluid in the refrigerant pipe 70. Therefore, because the temperature acquisition module 31 measures the temperature of the fluid in the temperature measurement container 30, the temperature measuring device 3 can highly accurately measure the temperature of the fluid in the refrigerant pipe 70. Thus, the accuracy of the airtightness test is improved.

In Embodiment 1, the differential pressure gauge 2 is connected with the refrigerant pipe 70 and the reference container 1. Thus, the differential pressure gauge 2 can measure the differential pressure ΔP between the pressure of the fluid in the refrigerant pipe 70 and the pressure of the fluid in the reference container 1.

In Embodiment 1, the temperature measurement container 30 has an external opening 35 through which a space in the temperature measurement container 30 and an external space communicate with each other and a seal material 36 that closes the external opening 35. The temperature measurement container 30 and the seal material 36 have such pressure resistance as to withstand a pressure higher than or equal to the first pressure corresponding to the set filling amount of the fluid into the refrigerant pipe 70. The temperature acquisition module 31 is provided in the seal material 36. Thus, it is possible to reduce the possibility that the temperature measurement container 30 and the seal material 36 will be damaged in the case where the set filling amount of the fluid is filled into the refrigerant pipe 70, with the inside of the refrigerant pipe 70 and the inside of the temperature measurement container 30 communicating with each other. Furthermore, since the seal material 36 is not damaged, the inside of the temperature measurement container 30 is kept shut off from the outside. Therefore, because the temperature acquisition module 31 measures the temperature of the fluid in the temperature measurement container 30, the temperature of the fluid in the refrigerant pipe 70 can be highly accurately measured. Thus, the accuracy of the airtightness test is improved.

In Embodiment 1, the first pressure is 2 MPa. Thus, the pressure resistance of the refrigerant pipe 70 during the test time is secured, and use of the fluid is reduced.

In Embodiment 1, the temperature measurement container 30 has a fluid-reception connection port 33 through which a fluid that flows out from a fluid supply device 9 configured to supply the fluid to the refrigerant pipe 70 flows into the temperature measurement container 30. Thus, the temperature measurement container 30 as well as the refrigerant pipe 70 can be filled with the fluid.

In Embodiment 1, in the temperature measuring device 3, a first valve 34 is provided at the fluid-reception connection port 33. The first valve 34 allows passage of the fluid when being in an open state, and blocks passage of the fluid when being in the closed state. By opening the first valve 34, it is possible to supply the fluid to the refrigerant pipe 70. Furthermore, by closing the first valve 34, it is possible to prevent an excessive amount of the fluid that causes damage to the refrigerant pipe 70 from flowing into the refrigerant pipe 70.

The airtightness testing apparatus 100 according to Embodiment 1 further includes the pressure measuring device 17, the guide device 10, and the processing device 5. The pressure measuring device 17 measures the pressure of the fluid in the refrigerant pipe 70. The guide device 10 allows passage of the fluid between the inside of the refrigerant pipe 70 and the inside of the reference container 1 prior to the start of the test time, and blocks passage of the fluid between the inside of the refrigerant pipe 70 and the inside of the reference container 1 after the start of the test time. The processing device 5 determines whether the fluid leaks from the refrigerant pipe 70 or not based on the differential pressure ΔP measured by the pressure gauge 2 at the end of the test time, the initial pressure P1 measured by the pressure measuring device 17 at the start of the test time, the initial temperature T1 measured by the temperature measuring device 3 at the start of the test time, and the terminal temperature T2 measured by the temperature measuring device 3 at the end of the test time. Thus, the process of determining whether the fluid leaks from the refrigerant pipe 70 or not is automated, saving the worker for the test the trouble. Furthermore, in the above configuration, at the start of the test time, the initial pressure P1 of the fluid in the refrigerant pipe 70 and the pressure of the fluid in the reference container 1 become equal to each other. At the end of the test time, it becomes possible to determine, from the differential pressure ΔP measured by the differential pressure gauge 2, whether the fluid leaks from the refrigerant pipe 70 or not. Furthermore, the temperature measuring device 3 obtains a variation between the pressure of the fluid in the refrigerant pipe 70 before the test time and the pressure of the fluid in the refrigerant pipe 70 after the test time, thereby obtaining a variation in the pressure of the fluid in the refrigerant pipe 70. Although the differential pressure ΔP measured by the differential pressure gauge 2 is affected by the change in pressure, the processing device 5 determines whether the fluid leaks or not by referring to the differential pressure ΔP measured by the differential pressure gauge 2 and the variation of the change of the voltage. Thus, the accuracy of the airtightness is improved.

In Embodiment 1, the processing device 5 calculates the terminal pressure P2 of the fluid in the refrigerant pipe at the end of the test time, based on the initial pressure P1, the initial temperature T1, and the terminal temperature T2. The processing device 5 determines whether the fluid leaks from the refrigerant pipe 70 or not based on the difference between the initial pressure P1 and the terminal pressure P2 and the differential pressure ΔP measured by the differential pressure gauge 2 at the end of the test time. In the above configuration, the processing device 5 can obtain a theoretical variation of the pressure during the test time by calculating the terminal pressure P2 based on the initial pressure P1, the initial temperature T1, and the terminal temperature T2 and calculating the difference between the initial pressure P1 and the terminal pressure P2. Although the differential pressure ΔP measured by the differential pressure gauge 2 is affected by the variation in pressure, whether the fluid leaks from the refrigerant pipe 70 or not can be determined with a high degree of accuracy, as the processing device 5 uses the variation in pressure together with the differential pressure ΔP measured by the differential pressure gauge 2.

In Embodiment 1, the reference container 1 has heat insulating properties. When a magnitude of the difference between the differential pressure AP, which is a difference obtained by subtracting the pressure of the fluid in the refrigerant pipe 70 from the pressure of the fluid in the reference container 1, and the difference obtained by subtracting the terminal pressure P2 from the initial pressure P1 is greater than a predetermined first threshold a, the processing device 5 determines that the fluid leaks. It should be noted that the differential pressure ΔP is measured at the end of the test time. In the above configuration, the initial pressure P1 of the fluid in the refrigerant pipe 70 and the pressure of the fluid in the reference container 1 become equal to each other at the start of the test time. Furthermore, since the temperature of the fluid in the reference container 1 is constant both prior to and posterior to the test time, the pressure of the fluid in the reference container 1 at the end of the test time is considered equal to the initial pressure P1. Therefore, the difference obtained by subtracting the terminal pressure P2 from the initial pressure P1 is equal to a theoretical difference obtained by subtracting the pressure of the fluid in the refrigerant pipe 70 from the pressure of the fluid in the reference container 1 at the end of the test time. When the differential pressure ΔP measured at the end of the test time is different, by more than the first threshold a, from the difference obtained by subtracting the terminal pressure P2 from the initial pressure P1, it is conceivable that the fluid leaks from the refrigerant pipe 70 and the pressure of the fluid in the refrigerant pipe 70 drops. Therefore, using the airtightness testing apparatus 100 according to Embodiment 1, it is possible to highly accurately check the airtightness of the refrigerant pipe 70.

In Embodiment 1, the temperature measuring device 3 is provided with a first attachment tool 38 for detachably attaching the temperature measuring device 3 to an attachment target in the outdoor unit 7. Thus, in the airtightness test, the temperature measuring device 3 can be set in the same environment as the refrigerant pipe 70 in the outdoor unit 7. Therefore, the state of the fluid in the temperature measurement container 30 become the same as the state of the fluid in the refrigerant pipe 70, and the temperature measuring device 3 can thus highly accurately measure the temperature of the fluid in the refrigerant pipe 70. Accordingly, the accuracy of the airtightness test is improved.

In Embodiment 1, the temperature measurement container 30 has a pipe-side connection port 32 through which the temperature measurement container 30 communicates with the refrigerant pipe 70. As a result, the inside of the temperature measurement container 30 and the inside of the refrigerant pipe 70 communicate with each other. Therefore, the state of the fluid in the temperature measurement container 30 can be made the same as the state of the fluid in the refrigerant pipe 70. Thus, the temperature measuring device 3 can measure the temperature of the fluid in the refrigerant pipe 70 by measuring the temperature of the fluid in the temperature measurement container 30.

In Embodiment 1, at the pipe-side connection port 32 of the temperature measurement container 30, a branching tool 8 is provided. The branching tool 8 is configured to connect, to the temperature measurement container 30, an inspection pipe 6 connected with the differential pressure gauge 2 and an inspection pipe 6 connected with the refrigerant pipe 70. Accordingly, the differential pressure gauge 2 and the temperature measuring device 3 can be connected together with the refrigerant pipe 70.

In Embodiment 1, the differential pressure gauge 2 is provided with the second attachment tool 20 for detachably attaching the differential pressure gauge 2 to an attachment target in the outdoor unit 7. Thus, the differential pressure gauge 2 and the temperature measuring device 3 can be provided together in the outdoor unit 7. In addition, it is possible to shorten an inspection pipe 6 which connects the differential pressure gauge 2 to the refrigerant pipe 70.

### Embodiment 2

In Embodiment 1, the temperature measuring device 3 and the differential pressure gauge 2 are provided in the outdoor unit 7. However, in some kinds of air-conditioning apparatuses, the inside of an outdoor unit 7 is narrow, and thus, a temperature measuring device 3 and a differential pressure gauge 2 cannot be housed in the outdoor unit 7. In an airtightness testing apparatus 100 according to Embodiment 2, the temperature measuring device 3 is provided inside the outdoor unit 7 and that the differential pressure gauge 2 is provided outside the outdoor unit 7. The airtightness testing apparatus 100 according to Embodiment 2 will be described. It should be noted that regarding Embodiment 2, components that are similar to those of Embodiment 1 will be denoted by the same reference signs. Furthermore, regarding Embodiment 2, descriptions concerning configurations that are similar to those in Embodiment 1 and functions that are similar to that in Embodiment 1 will be omitted unless the circumstances are exceptional.

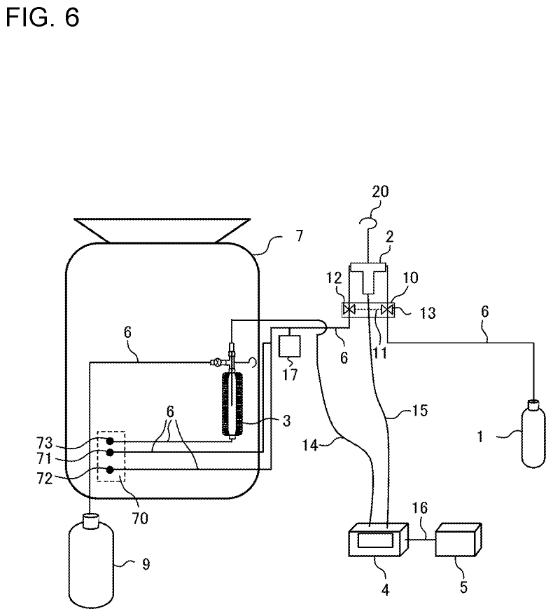

FIG. 6 is a schematic view illustrating an example of installation of the airtightness testing apparatus according to Embodiment 2. It should be noted that the components of the airtightness testing apparatus 100 according to Embodiment 2 are illustrated by FIG. 1 as in Embodiment 1. As in Embodiment 1, the temperature measuring device 3 is set by the first attachment tool 38 at a location in the outdoor unit 7 that is separated from the refrigerant pipe 70 by a distance shorter than or equal to the first distance. Meanwhile, the differential pressure gauge 2 is attached to a component located the outside of the outdoor unit 7, by the second attachment tool 20.

In Embodiment 2, the differential pressure gauge 2 is connected with the refrigerant pipe 70. In this case, the temperature measuring device 3 is not provided between the differential pressure gauge 2 and the refrigerant pipe 70. The differential pressure gauge 2 is connected with the high-pressure coupling 71 and the low-pressure coupling 72 by respective inspection pipes 6. To be more specific, part of the inspection pipe 6 that is closed to the refrigerant pipe 70 branches into two inspection pipes 6 one of which is connected with the high-pressure coupling 71 and the other of which is connected with the low-pressure coupling 72. Part of the inspection pipe 6 that is close to the differential pressure gauge 2 does not branch, and at this part of the inspection pipe 6, the fluid from the high-pressure coupling 71 and the fluid from the low-pressure coupling 72 join each other. At the part of the inspection pipe 6 that is close to the differential pressure gauge 2, the second valve 12 and the pressure measuring device 17 are provided. It should be noted that the pressure measuring device 17 is provided between the second valve 12 and the refrigerant pipe 70.

The temperature measuring device 3 is connected with the refrigerant pipe 70 by an inspection pipe 6. In this case, one of ends of the inspection pipe 6 is connected with the pipe-side connection port 32 of the temperature measurement container 30, and the other end is connected with the refrigerant pipe 70. Thus, the inside of the temperature measurement container 30 and the inside of the refrigerant pipe 70 communicate with each other. In Embodiment 2, the inspection pipe 6 connecting the temperature measuring device 3 to the refrigerant pipe 70 has an end that is close to the refrigerant pipe 70 and that is set at an operated valve 73 at the refrigerant pipe 70. The operated valve 73 is configured to control the flow rate of the fluid. The operated valve 73 may be a liquid operated valve that controls the flow rate of a liquid fluid or may be a gas operated valve that controls the flow rate of a gas fluid.

The temperature measuring device 3 is connected with the fluid supply device 9 by an inspection pipe 6. The inspection pipe 6 connected with the fluid supply device 9 is connected with the fluid-reception connection port 33 of the temperature measurement container 30. When the first valve 34 and the supply side valve are opened, the fluid flows out from the fluid supply device 9 into the temperature measurement container 30 and into the refrigerant pipe 70. The fluid supplied from the fluid supply device 9 into the refrigerant pipe 70 flows to the differential pressure gauge 2 via the inspection pipe 6 connecting the refrigerant pipe 70 to the differential pressure gauge 2. At this time, when the second valve 12 and the third valve 13 are opened, the fluid is also supplied to the reference container 1.

The flow of the processes in the first half of an airtightness test according to Embodiment 2 is indicated by FIG. 4, and the flow of the processes in the second half is indicated by FIG. 5. The processing in the airtightness test according to Embodiment 2 is the same as that of Embodiment 1 except for the following.

In Embodiment 2, in step S1, the first valve 34, the second valve 12, and the third valve 13 are made to be in the open state, and the supply side valve is made to be in the open state. In Embodiment 1, when these valves are made to be in the open state, the fluid that has flowed out from the fluid supply device 9 flows into the temperature measurement container 30, and the fluid that has flowed into the temperature measurement container 30 flows into the refrigerant pipe 70 and the reference container 1. In Embodiment 2, when the above valves are made into the .open state, the fluid that has flowed out from the fluid supply device 9 flows into the refrigerant pipe 70 via an inspection pipe 6 and the temperature measurement container 30, and the fluid that has flowed into the refrigerant pipe 70 flows into the reference container 1 via the inspection pipes 6 and the branch pipe 11. Thus, the refrigerant pipe 70 and the reference container 1 are filled with the fluid.

The advantages of the airtightness testing apparatus 100 according to Embodiment 2 will be described. In Embodiment 2, the differential pressure gauge 2 is provided outside an outdoor unit 7. It should be noted that the differential pressure gauge 2 is provided with a second attachment tool 20 for detachably attaching the differential pressure gauge 2 to an attachment target. Since the differential pressure gauge 2 is provided outside the outdoor unit 7, it is possible to easily handle the differential pressure gauge 2. It is possible to promptly perform handling in the case where the differential pressure ΔP between the pressure of the fluid in the refrigerant pipe 70 and the pressure of the fluid in the reference container 1 is so great as to exceed the measurement range of the differential pressure gauge 2.

### Embodiment 3

The airtightness testing apparatuses 100 according to Embodiments 1 and 2 each include the temperature measuring device 3 which measures the temperature of the fluid. In Embodiments 1 and 2, the airtightness test is conducted based on the temperature measured by the temperature measuring device 3. In contrast, an airtightness testing apparatus 200 according to Embodiment 3 is configured to conduct the airtightness test without measuring the temperature of the fluid. The airtightness testing apparatus 200 according to Embodiment 3 will be described below. It should be noted that components in Embodiment 3 that are the same as to those in each of Embodiments 1 and 2 will be denoted by the same reference signs. Furthermore, descriptions concerning configurations in Embodiment 3 that are the same as those in each of Embodiments 1 and 2 and descriptions concerning functions in Embodiment 3 that are the same as those in each of Embodiments 1 and 2 will be omitted unless the circumstances are exceptional.

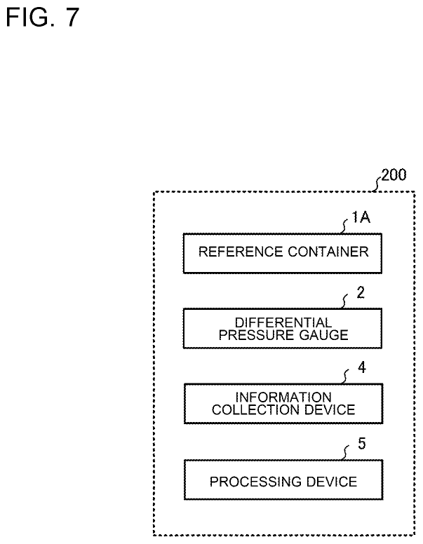

FIG. 7 is a block diagram illustrating a configuration example of the airtightness testing apparatus 200 according to Embodiment 3. As in Embodiments 1 and 2, the airtightness testing apparatus 200 includes the differential pressure gauge 2, the information collection device 4, and the processing device 5. The airtightness testing apparatus 200 includes a reference container 1A in place of the reference container 1 of Embodiments 1 and 2. The airtightness testing apparatus 200 does not include the temperature measuring device 3 of Embodiments 1 and 2. In order that the components of the airtightness testing apparatus 200 be easily understood, FIG. 7 shows the reference container 1A, the differential pressure gauge 2, etc., in a dashed frame. However, it is not indispensable that those components are provided together in one housing.

The reference container 1A does not have heat-insulating properties, but easily performs heat exchange as in the temperature measuring device 3. The reference container 1A in Embodiment 3 satisfies one or both of a condition that the thermal diffusivity of the reference container 1A is higher than or equal to that of the refrigerant pipe 70 and a condition that the thermal conductivity of the reference container 1A is higher than or equal to that of the refrigerant pipe 70.

At an outer wall of the reference container 1A, a plurality of fins may be provided. In this case, the reference container 1A may have a cylindrical shape, and the plurality of fins may be provided at an outer circumferential portion of the reference container 1A.

The reference container 1A and the refrigerant pipe 70 may be formed of the same material. For example, the reference container 1A may be made of copper, which is widely used as the material of the refrigerant pipe 70.

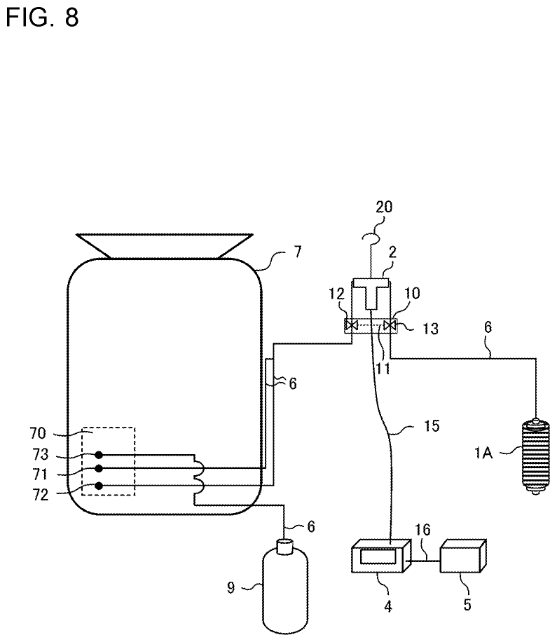

FIG. 8 is a schematic view illustrating an example of installation of the airtightness testing apparatus according to Embodiment 3. The reference container 1A is provided in the same environment as the outdoor unit 7, for example, in an outdoor region. In Embodiment 3, it is not indispensable that the pressure measuring device 17 is provided. The fluid supply device 9 is connected with the refrigerant pipe 70 by an inspection pipe 6. In this case, one of ends of the inspection pipe 6 is provided at a supply port of the fluid supply device 9 through which the fluid is supplied, and the other end is provided at the operated valve 73 in the refrigerant pipe 70.

The differential pressure gauge 2 is provided outside or inside the outdoor unit 7 by the second attachment tool 20. As in Embodiment 2, the differential pressure gauge 2 is connected with the high-pressure coupling 71 and the low-pressure coupling 72 by respective inspection pipes 6. The differential pressure gauge 2 is connected with the reference container 1A via an inspection pipe 6 and the guide device 10. The third valve 13 is provided at the inspection pipe 6 connecting the differential pressure gauge 2 to the reference container 1A and also at the branch pipe 11.

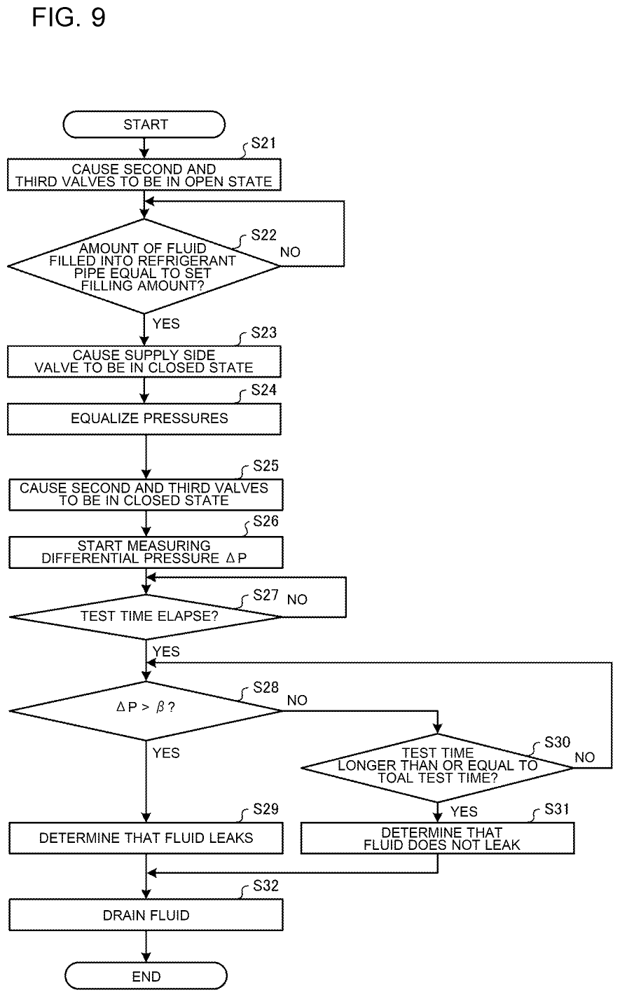

FIG. 9 is a flow chart of the flow of processes of an airtightness test according to Embodiment 3. In step S21, the second valve 12 and the third valve 13 are made to be in the open state by the control by the processing device 5, or manually made to be in the open state by the worker for the test. At this point in time, the supply side valve in the fluid supply device 9 is also made to be in the open state by the control by the processing device 5 or manually made to be in the open state by the worker for the test. As a result, the fluid flows out from the fluid supply device 9 and flows into the refrigerant pipe 70 via an inspection pipe 6. Then, the fluid that has flowed into the refrigerant pipe 70 flows into the reference container 1 via the inspection pipes 6 and the branch pipe 11. Thus, the fluid is filled into the refrigerant pipe 70 and the reference container 1.

The processes of steps S22 to S24 are similar to the processes of steps S2 to S4. In step S25, the second valve 12 and the third valve 13 are made to be in the closed state by the control by the processing device 5 or manually made to be in the closed state by the worker for the test. The process of step S26 is similar to the process of step S8.

In step S27, the processing device 5 or the worker for the test determines whether the test time elapses from the process of step S25 or not. When it is determined that the test time does not elapse (NO in step S27), the processing in the airtightness test is kept in step S27. When it is determined that the test time elapses (YES in step S27), in step S28, the processing device 5 or the worker for the test determines whether the differential pressure ΔP measured at the end of the test time is greater than a second threshold B or not. The second threshold B is determined in advance as a value greater than 0, based on the result of an experiment or other methods, in order to prevent occurrence of a leak of the fluid from being determined by mistake even when the differential pressure ΔP falls within an allowable range that is a margin for error.

When the differential pressure ΔP is greater than the second threshold B (YES in step S28), in step S29, the processing device 5 or the worker for the test determines that the fluid leaks from the refrigerant pipe 70. After the process of step S29, the process of step S32 is executed.

When the differential pressure ΔP is less than or equal to the second threshold β (NO in step S28), in step S30, the processing device 5 or the worker for the test determines whether the total test time elapses from the process of step S25 or not. When the total test time does not elapse (NO in step S30), the processing is returned to step S28. In this case, after the standby time elapses from the point in time at which the process of step S30 is performed, the processing is returned to step S28. In the case where the processing is returned to step S28 after the standby time elapses, it is assumed that the test time is a period of time obtained by adding the standby time to the original test time.

When the total test time elapses (YES in step S30), in step S31, the processing device 5 or the worker for the test determines that the fluid does not leak from the refrigerant pipe 70. After the process of step S31, the process of step S32 is executed.

The process of step S32 is similar to the process of step S17. After the process of step S32, the airtightness testing processing ends.

Advantages of the airtightness testing apparatus 200 according to Embodiment 3 will be described. The airtightness testing apparatus 200 is configured to conduct a test on the airtightness of a refrigerant pipe 70 in an air-conditioning apparatus, and includes the reference container 1A and the differential pressure gauge 2. The reference container 1A is an airtight container. The differential pressure gauge 2 measures a differential pressure ΔP between the pressure of a fluid filled into the refrigerant pipe 70 and the pressure of a fluid filled into the reference container 1A. The reference container 1A satisfies one or both of a condition that the thermal diffusivity of the reference container 1A is higher than or equal to that of the refrigerant pipe 70 and a condition that the thermal conductivity of the reference container 1A is higher than or equal to that of the refrigerant pipe 70.

In the above configuration, the rate of a change in the temperature of the reference container 1A that is made by a change in the outdoor air temperature is higher than or equal to the rate of a change in the temperature of the refrigerant pipe 70 that is made by the change in the outdoor air temperature. Therefore, in the case where the outdoor air temperature changes, the temperature of the fluid in the reference container 1A changes at a rate higher than or equal to the rate of the change in temperature of the fluid in the refrigerant pipe 70. This reduces a delay in the change in the temperature of the fluid in the reference container 1A from the change in the temperature of the fluid in the refrigerant pipe 70. Thus, the temperature of the fluid in the refrigerant pipe 70 and the temperature of the fluid in the reference container 1A immediately come close to each other. It is therefore possible to reduce the difference between the pressures of the above fluids, which is made by only the difference in temperature between the refrigerant pipe 70 and the reference container 1A. Accordingly, it is unnecessary to consider variation of the pressure of the fluid in the refrigerant pipe 70 that is made by variation of the temperature of the fluid in the refrigerant pipe 70. Thus, it is also unnecessary to measure the temperature of the fluid in the refrigerant pipe 70 or calculate the terminal pressure P2 based on the temperature. Therefore, the airtightness testing apparatus 200 can highly accurately conduct the airtightness test only based on the differential pressure ΔP measured by the differential pressure gauge 2 and shorten the testing step.

In Embodiment 3, the reference container 1A is provided in the same environment as the outdoor unit 7. It should be noted that in many cases, the outdoor temperature more greatly varies than the indoor temperature. Thus, the temperature of the fluid in the refrigerant pipe 70 is considered to more greatly vary due to a change in the temperature in the outdoor unit 7 than due to a change in the temperature in the indoor unit. In Embodiment 3, since the reference container 1A is provided in the same environment as the outdoor unit 7, the temperature of the fluid in the reference container 1A comes close to the temperature of the fluid in the refrigerant pipe 70 in the outdoor unit 7. It is therefore possible to reduce the difference between the pressures of the fluid, which is made by only the difference in temperature between the refrigerant pipe 70 and the reference container 1A. Thus, it is unnecessary to consider variation of the pressure of the fluid in the refrigerant pipe 70 that is made by variation of the temperature of the fluid in the refrigerant pipe 70. Accordingly, it is also unnecessary to measure the temperature of the fluid in the refrigerant pipe 70 or calculate the terminal pressure P2 based on the temperature. Thus, by using the airtightness testing apparatus 200, it is possible to highly accurately conduct the airtightness test only based on the differential pressure ΔP measured by the differential pressure gauge 2 and shorten the testing step.

In Embodiment 3, at the outer wall of the reference container 1A, a plurality of fins are provided. Thus, a contact area between the reference container 1A and outdoor air is increased, and heat exchange is easily performed between a body of the reference container 1A and outdoor air. As a result, the fluid in the reference container 1A easily exchanges heat with outdoor air via the wall of the reference container 1A. Therefore, it is possible to reduce a delay in the change in the temperature of the fluid in the reference container 1A from the change in the temperature of the fluid in the refrigerant pipe 70. Thus, it is possible to promptly and highly accurately conduct the airtightness test on based on the differential pressure ΔP measured by the differential pressure gauge 2.

In Embodiment 3, the reference container 1A and the refrigerant pipe 70 are made of the same material. Thus, the fluid in the reference container 1A exchanges heat with outdoor air in the same manner as the fluid in the refrigerant pipe 70. Accordingly, the temperature of the fluid in the reference container 1A comes close to the temperature of the fluid in the refrigerant pipe 70. Thus, it is possible to reduce the difference between the pressures of the fluids, which is made by only the difference in temperature between the refrigerant pipe 70 and the reference container 1A. Therefore, it is also unnecessary to measure the temperature of the fluid in the refrigerant pipe 70 or calculate the terminal pressure P2 based on the temperature. Accordingly, by using the airtightness testing apparatus 200, it is possible to highly accurately conduct the airtightness test only based on the differential pressure AP measured by the differential pressure gauge 2 and shorten the testing step.

The airtightness testing apparatus 200 according to Embodiment 3 further includes the guide device 10. The guide device 10 allows passage of the fluid between the inside of the refrigerant pipe 70 and the inside of the reference container 1 prior to the start of a test time that is set for the test, and blocks passage of the fluid between the inside of the refrigerant pipe 70 and the inside of the reference container 1 after the start of the test time. Thus, the pressure of the fluid in the refrigerant pipe 70 and the pressure of the fluid in the reference container 1 are uniformized before the start of the test time. By checking the differential pressure ΔP measured by the differential pressure gauge 2 at the end of the test time, the worker for the test can promptly and easily determine whether the fluid leaks from the refrigerant pipe 70 or not.

The airtightness testing apparatus 200 according to Embodiment 3 further includes the processing device 5. The processing device 5 determines whether the fluid leaks from the refrigerant pipe 70 or not based on the differential pressure AP measured by the differential pressure gauge 2 at the end of the test time. Thus, the airtightness test is automated.

Although the embodiments are described above, the contents of the present disclosure are not limited to the embodiments but encompass a range of equivalents that are conceivable.

1. An airtightness testing apparatus to test airtightness of a refrigerant pipe in an air-conditioning apparatus, the airtightness testing apparatus comprising:
a differential pressure gauge configured to measure a differential pressure that is a difference between a pressure of a fluid filled into the refrigerant pipe and a pressure of a fluid filled into a reference container that is airtight; and
a temperature measuring device connected with the refrigerant pipe, and configured to measure a temperature of the fluid in the refrigerant pipe,
wherein the temperature measuring device includes
a temperature measurement container that communicates with the refrigerant pipe and that is allowed to contain the fluid while being sealed, and
a temperature acquisition module provided in the temperature measurement container and configured to measure the temperature of the fluid, and
wherein the temperature measurement container is configured to satisfy one or both of a condition that a thermal diffusivity of the temperature measurement container is higher than or equal to a thermal diffusivity of the refrigerant pipe and a condition that a thermal conductivity of the temperature measurement container is higher than or equal to a thermal conductivity of the refrigerant pipe.

2. The airtightness testing apparatus of claim 1, wherein the temperature measuring device is provided in the same environment as an outdoor unit in the air-conditioning apparatus.

3. The airtightness testing apparatus of claim 1, wherein the temperature measuring device is provided in an outdoor unit in the air-conditioning apparatus.

4. The airtightness testing apparatus of claim 1, wherein in the temperature measurement container, a plurality of fins are provided.

5. The airtightness testing apparatus of claim 1, wherein the temperature measurement container is made of the same material as the refrigerant pipe.

6. The airtightness testing apparatus of claim 1, wherein the temperature measurement container is obtained by processing the refrigerant pipe.

7. The airtightness testing apparatus of claim 1, wherein the temperature measurement container has an inner capacity less than or equal to 50 cm³.

8. The airtightness testing apparatus of claim 1, wherein the differential pressure gauge is connected with the refrigerant pipe and the reference container and configured to measure the differential pressure that is the difference between the pressure of the fluid in the refrigerant pipe and the pressure of the fluid in the reference container.

9. The airtightness testing apparatus of claim 1, wherein
the temperature measurement container includes
an external opening through which a space in the temperature measurement container and an external space communicate with each other, and
a seal material configured to close the external opening,
the temperature measurement container and the seal material have such pressure resistance as to withstand a pressure higher than or equal to a first pressure corresponding to a set filling amount that is a set amount of the fluid which is filled into the refrigerant pipe, and
the temperature acquisition module is provided in the seal material.

10. The airtightness testing apparatus of claim 9, wherein the first pressure is 2 MPa.

11. The airtightness testing apparatus of claim 1, wherein the temperature measurement container has a fluid-reception connection port through which the fluid flowing out from a fluid supply device flows into the temperature measurement container, the fluid supply device being configured to supply the fluid to the refrigerant pipe.

12. The airtightness testing apparatus of claim 11, wherein the temperature measuring device includes a first valve that is provided at the fluid-reception connection port and that is configured to allow passage of the fluid when the first valve is in an open state and block passage of the fluid when the first valve is in a closed state.

13. The airtightness testing apparatus of claim 1, further comprising:
a pressure measuring device configured to measure the pressure of the fluid in the refrigerant pipe;
a processing device configured to determine whether the fluid leaks from the refrigerant pipe or not based on the differential pressure measured by the differential pressure gauge; and
a guide device configured to allow passage of the fluid between an inside of the refrigerant pipe and an inside of the reference container prior to a start of a test time that is set for the test, and block passage of the fluid between the inside of the refrigerant pipe and the inside of the reference container after the start of the test time,
wherein the processing device is configured to determine whether the fluid leaks from the refrigerant pipe or not based on the differential pressure measured by the pressure gauge at an end of the test time, an initial pressure, an initial temperature, and a terminal temperature, the initial pressure being the pressure measured by the pressure measuring device at the start of the test time, the initial temperature being the temperature measured by the temperature measuring device at the start of the test time, the terminal temperature being the temperature measured by the temperature measuring device at the end of the test time.

14. The airtightness testing apparatus of claim 13, wherein the processing device is configured to calculate a terminal pressure based on the initial pressure, the initial temperature, and the terminal temperature, the terminal pressure being the pressure of the fluid in the refrigerant pipe at the end of the test time, and is configured to determine whether the fluid leaks from the refrigerant pipe or not based on a difference between the initial pressure and the terminal pressure and the differential pressure measured by the differential pressure gauge at the end of the test time.

15. The airtightness testing apparatus of claim 14, wherein
the reference container has heat-insulating properties, and
the processing device is configured to determine that the fluid leaks, when a magnitude of a difference between the differential pressure and a difference obtained by subtracting the terminal pressure from the initial pressure is greater than a first threshold, the differential pressure being a difference obtained by subtracting the pressure of the fluid in the refrigerant pipe from the pressure of the fluid in the reference container.

16. The airtightness testing apparatus of claim 1, wherein the temperature measuring device is provided with a first attachment tool to detachably attach the temperature measuring device to an attachment target.

17. The airtightness testing apparatus of claim 1, wherein the temperature measurement container has a pipe-side connection port through which the temperature measurement container communicates with the refrigerant pipe.

18. The airtightness testing apparatus of claim 17, wherein at the pipe-side connection port, a branching tool is provided to connect, with the temperature measurement container, an inspection pipe connected with the differential pressure gauge and an inspection pipe connected with the refrigerant pipe.

19. The airtightness testing apparatus of claim 1, wherein at the different gauge, a second attachment tool is provided, the second attachment tool being configured to detachably attach the differential pressure gauge to an attachment target.

20. An airtightness testing apparatus to conduct a test on airtightness of a refrigerant pipe in an air-conditioning apparatus, the airtightness testing apparatus comprising:
a reference container that is airtight; and
a differential pressure gauge configured to measure a differential pressure that is a difference between a pressure of a fluid filled into the refrigerant pipe and a pressure of a fluid filled into the reference container,
wherein the reference container is configured to satisfy one or both of a condition that a thermal diffusivity of the reference container is higher than or equal to a thermal diffusivity of the refrigerant pipe and a condition that a thermal conductivity of the reference container is higher than or equal to a thermal conductivity of the refrigerant pipe.

21. The airtightness testing apparatus of claim 20, wherein the reference container is provided in the same environment as an outdoor unit.

22. The airtightness testing apparatus of claim 20, wherein the reference container has an outer wall at which a plurality of fins are provided.

23. The airtightness testing apparatus of claim 20, wherein the reference container is made of the same material the refrigerant pipe.

24. The airtightness testing apparatus of claim 20, further comprising a guide device configured to allow passage of the fluid between an inside of the refrigerant pipe and an inside of the reference container prior to a start of a test time that is set for the test, and block passage of the fluid between the inside of the refrigerant pipe and the inside of the reference container after the start of the test time.

25. The airtightness testing apparatus of claim 24, further comprising a processing device configured to determine whether the fluid leaks from the refrigerant pipe or not based on the differential pressure measured by the differential pressure gauge at an end of the test time.

26. An airtightness testing method that is applied by an airtightness testing apparatus to conduct a test on airtightness of a refrigerant pipe in an air-conditioning apparatus, the airtightness testing apparatus including a temperature measuring device connected with the refrigerant pipe,
wherein the temperature measuring device includes
a temperature measurement container that communicates with the refrigerant pipe and that is allowed to contain the fluid while being sealed, and
a temperature acquisition module provided in the temperature measurement container and configured to measure a temperature of the fluid, and
wherein the temperature measurement container is configured to satisfy one or both of a condition that a thermal diffusivity of the temperature measurement container is higher than or equal to a thermal diffusivity of the refrigerant pipe and a condition that a thermal conductivity of the temperature measurement container is higher than or equal to a thermal conductivity of the refrigerant pipe,
the airtightness testing method being applied, with the temperature measuring device set in an outdoor unit in the air-conditioning apparatus, the airtightness testing method comprising:
measuring a differential pressure that is a difference between a pressure of the fluid filled in the refrigerant pipe and a pressure of the fluid filled in a reference container that is airtight; and
measuring the temperature of the fluid in the refrigerant pipe.

27. An airtightness testing method that is applied by an airtightness testing apparatus to conduct a test on airtightness of a refrigerant pipe in an air-conditioning apparatus, the airtightness testing apparatus including a temperature measuring device connected with the refrigerant pipe,
wherein the temperature measuring device includes
a temperature measurement container that communicates with the refrigerant pipe and that is allowed to contain the fluid while being sealed, and
a temperature acquisition module provided in the temperature measurement container and configured to measure a temperature of the fluid, and
the temperature measurement container is configured to satisfy one or both of a condition that a thermal diffusivity of the temperature measurement container is higher than or equal to a thermal diffusivity of the refrigerant pipe and a condition that a thermal conductivity of the temperature measurement container is higher than or equal to a thermal conductivity of the refrigerant pipe,
the airtightness testing method being performed, with the temperature measuring device set in the same environment as an outdoor unit in the air-conditioning apparatus is provided, the airtightness testing method comprising:
measuring a differential pressure that is a difference between a pressure of the fluid filled in the refrigerant pipe and a pressure of the fluid filled in a reference container that is airtight; and
measuring the temperature of the fluid in the refrigerant pipe.

28. (canceled)
